(19) United States
(12) Patent Application Publication
(10) Pub. No.: US 2014/0279102 A1
(43) Pub. Date: Sep. 18, 2014

(54) FRAUD DETECTION

(71) Applicant: Avero LLC, (US)

(72) Inventors: Zoe Hartman, Washington, DC (US); Gregory Peppel, Brooklyn, NY (US); James Broude, Hastings on Hudson, NY (US); Richard Chinitz, New York, NY (US); Doug Hsieh, New York, NY (US); Damian Mogavero, New York, NY (US)

(73) Assignee: Avero LLC, New York, NY (US)

(21) Appl. No.: 13/839,703

(22) Filed: Mar. 15, 2013

(51) Int. Cl. G06Q 20/40; G06Q 20/20

(52) U.S. Cl. CPC G06Q 20/4016; G06Q 20/206
USPC 705/18

(57) ABSTRACT

A system and method of fraud detection is disclosed including identification of a group of employees and bills associated with each employee of the group. For each bill, at least two conditions of the following conditions are determined: whether a complimentary condition has been met, whether a transfer condition has been met, whether a void and promotion condition has been met, whether a gratuity inflation condition has been met, whether a point of sale authorization condition has been met, whether an automatic gratuity condition has been met, and whether a bill reuse condition has been met. A score corresponding to each of the determined conditions is calculated and a total score for each employee is established based on the score for the determined conditions for each of the bills. Each employee of the group is rated based on the employee's total score.

### BACKGROUND

1. Field

The present disclosure generally relates to fraud detection, and more particularly to detecting fraud at the point of sale of a business by analyzing each transaction.

2. Background of the Invention

Businesses such as hotels, restaurants, spas, and retail stores lose money through employee theft. Theft may occur at the point of sale in several ways when employees manipulate cash transactions, coupons, promotions, and “comps.” Monitoring of employees is currently performed by manually reviewing transactions and comparing them to transactions of the employee's peers. However, manual analysis and monitoring is time consuming, difficult, and costly. Manual investigation and tracking of suspicious transactions requires additional time and costs. There is a need for an efficient and thorough way to identify and investigate suspicious transactions in order to minimize employee theft.

### SUMMARY

A computer implemented method of fraud detection is disclosed in which a group of employees is identified, wherein the group of employees includes a plurality of employees, and a plurality of bills of each employee of the group is identified. The method also includes determining, for each bill, whether a plurality of conditions have been met, where the determined conditions include at least two of: whether a complimentary condition has been met, whether a transfer condition has been met, whether a void and promotion condition has been met, whether a gratuity inflation condition has been met, whether a point of sale authorization condition has been met, whether an automatic gratuity condition has been met, and whether a bill reuse condition has been met. The method further includes calculating a score corresponding to each of the determined conditions, establishing a total score for each employee of the group based on the score for the determined conditions for each of the plurality of bills, and rating each employee of the group based on the total score of each employee of the group.

A system for fraud detection is disclosed the system includes one or more processors and a memory containing processor-executable instructions that, when executed by the one or more processors, cause the system to identify a group of employees, where the group of employees includes a plurality of employees and identify a plurality of bills of each employee of the group. The system is further caused to determine, for each bill, whether a plurality of conditions have been met, where the determined conditions include: whether a complimentary condition has been met, whether a transfer condition has been met, whether a void and promotion condition has been met, whether a gratuity inflation condition has been met, whether a point of sale authorization condition has been met, whether an automatic gratuity condition has been met, and whether a bill reuse condition has been met. The system is further caused to calculate a score corresponding to each of the determined conditions, establish a total score for each employee of the group based on the score for the determined conditions for each of the plurality of bills, and rate each employee of the group based on the total score of each employee of the group.

A machine-readable storage medium storing machine-executable instructions for causing a processor to perform a method for fraud detection is disclosed in which the method includes identifying a group of employees, where the group of employees includes a plurality of employees and identifying a plurality of bills of each employee of the group. The method further includes determining, for each bill, whether a plurality of conditions have been met, wherein the determined conditions include at least two of: whether a complimentary condition has been met, whether a transfer condition has been met, whether a void and promotion condition has been met, whether a gratuity inflation condition has been met, whether a point of sale authorization condition has been met, whether an automatic gratuity condition has been met, and whether a bill reuse condition has been met. The method further includes calculating a score corresponding to each of the determined conditions, establishing a total score for each employee of the group based on the score for the determined conditions for each of the plurality of bills, rating each employee of the group based on the total score of each employee of the group, and sending an alert to a client device based on one or more employees.

### BRIEF DESCRIPTION OF THE DRAWINGS

FIG. 1 illustrates an example system for fraud detection.

FIG. 2 is a block diagram of an example system for fraud detection.

FIG. 3 illustrates an example process for fraud detection.

FIG. 4 illustrates an example process for fraud detection.

FIG. 5 illustrates an example graphical user interface of the method and system of fraud detection.

FIG. 6 illustrates an example graphical user interface of the method and system of fraud detection.

### DETAILED DESCRIPTION

In the following detailed description, numerous specific details are set forth to provide a full understanding of the subject technology. It will be apparent, however, that different aspects of the subject technology may be practiced without some of these specific details. In other instances, well-known structures and techniques have not been shown or described so as not to obscure the disclosure but are contemplated.

The fraud detection method and system of the subject technology provides the benefit of creating proactive fraud alerts, pinpointing high-risk employees, and detecting a variety of types of fraud at the point of sale. Additional benefits of the subject technology include providing easy investigation once fraud has been detected and providing an employer or other managing user with a convenient and easy way to continue to monitor a suspicious employee or set of occurrences. The subject technology also provides the benefit of an automatic process of analysis which minimizes the need for manual analysis of point of sale transactions and data. The subject technology additionally provides the benefit of continuous monitoring twenty-four hours a day, seven days a week.

FIG. 1 illustrates an example system 100 for fraud detection. Employees perform transactions 102 in a business by creating bills for customers of a business. Transactions may be identified by employee and details of each transaction 102 may be collected at the point of sale. Details of each transaction may be analyzed to identify whether several conditions have been met 110 including, but not limited to, “comps”, gratuity inflation, transfers, voids and promotions, automatic gratuities, point of sale (POS) authorizations, and bill reuse. The conditions are then used to determine whether each employee's transactions 102 are suspicious. Employees that have been identified as suspicious 103 may then be isolated and tracked to determine whether the suspicious behavior indicates that fraud has occurred.

FIG. 2 is a block diagram of an example system 100 for fraud detection. System 100 may include server 230, employer/managing user client device 250, and point of sale client device 270, all of which are operatively connected, either directly or indirectly, over network 220. Components of system 100 may be connected through a wired or wireless network as known in the art. Clients 250 and 270 may be devices such as, a general or specific purpose computer, a desktop computer, a laptop computer, a tablet computer, a smart phone, set top box, or any other computing device with a processor, memory, and communications capabilities. The system 100 may include multiple client devices 270 and 250. Client devices 250 and 270 may include one or more processors 251 and 271, respectively, that are capable of executing instructions that are either physically coded into the processors 251 and 271 and/or provided from a software module 259 and 279, respectively in memories 255 and 275. Memories 255 and 275 may each be housed locally in client devices 250 and 270, accessed remotely from a remote server, or may be a combination of local and remote memories as would be understood by those of ordinary skill in the art. Stored instructions may provide information to a user and/or allow a user to input information through input/out devices integral to or associated with client devices 250 and 270 (not shown). Memory 275 of the client device 270 may additionally include a database 277 in which employee transaction information is stored. Employee transaction information may additionally or alternatively be stored in memory 235 of server 230. Memory 255 of client 250 may additionally include database 257 in which alert, case, employee, or status information may be stored. Alert, case, employee, or status information may be alternatively or additionally stored in memory 235. Client devices 250 and 270 may be the same device. Client devices functioning as both point of sale client devices 270 and employer/managing user client devices 250 may require managing users and employees to log in to a user accounts with a password to ensure privacy.

Server 230 includes processor 231 and memory 235. Memory 235 may include software module 239 and database 237. Server 230 may include one or more servers that are capable of executing instructions that are either physically coded into processor 231 and/or provided from a software module 239. Memory 235 may be stored locally in server 230 or may be located in multiple servers. Database 237 may store employee transaction information received from client 270 via network 220. Software module 239 may perform steps of the method as discussed below in FIGS. 3-4 and store the resulting information (including alerts) in database 237. Reports and other additional information may be generated through software module 239 based on transaction information received from client device 270 and resulting information stored in database 237. Such results may be communicated to client device 250 through the network 220.

FIG. 3 illustrates an example process 300 for fraud detection. In step 300, a group of employees are identified, where the group of employees may include a plurality of employees. The group of employees may be identified based on the type of employee working during a specific time period for one enterprise of a business. The term “business” as used herein encompasses its plain and ordinary meaning, including, but not limited to one or more retail or service entity, organization, or charity that engages in transactions in which goods, services, or a combination of goods and services are provided in exchange for money. A business may accept offers including promotions, vouchers, “comps”, or coupons as a portion of the payment or as the entire payment. Examples of businesses include hotels, casinos, cruise ships, restaurants, bars, clubs, lounges, spas, apparel stores, music or other performance venues, and museums.

The group of employees may be determined as a plurality of employees. For example, the plurality of employees may be determined in step 300 by using the example process 400 for fraud detection illustrated in FIG. 4. In step 400, at least one enterprise of a business is determined. An “enterprise” as used herein encompasses its plain and ordinary meaning, including, but not limited to a revenue center of a business. Revenue centers may be determined as having at least a threshold amount of the total business sales. One exemplary threshold amount may be greater than ten percent of the total sales. An enterprise of a business may be determined by other criteria including type of good or service offered, location of transaction, type of transaction, or the like. Examples of enterprises for a hotel business may include but are not limited to: all dining, bar, café, casino service, pool, room service, and seasonal revenue centers. An additional enterprise may be specified for unknown or other business sales that do not fall under an established enterprise. A business may have a single enterprise and the number of enterprises that a business has may be unlimited. Enterprises of a business may be changed at any time and may vary over time to reflect seasonal or periodic changes in business sales as well as the evolution of the business over time. Enterprises may be determined by an employer or managing user. Separate enterprises may be established for the purpose of isolating transactions of separate areas of a business to more accurately identify fraud that is specific to that area of the business.

One or more time periods of operation may be determined for the enterprise in step 410. The term “time period of operation” as used herein encompasses its plain and ordinary meaning, including, but not limited to a period of time during which transactions are made in an enterprise and/or business. The period of time may be representative of the operating hours for the enterprise and/or business for a single day, week, or other period of time. The period of time may be determined as having at least a threshold amount of the total sales of the enterprise and/or business. One exemplary threshold amount may be ten percent of the total sales of the enterprise and/or business as determined by a day, week, month, year, or the like. Examples of periods of time for a restaurant may include but are not limited to dinner shift, swing shift, lunch shift, brunch shift, breakfast shift, all day, all night, and late night. An additional period of time may be specified as “unknown or other” which may encompass business transactions occurring during a period of time that is not otherwise specified. A business and/or enterprise may have a single period of time or the number of periods of time may be unlimited. Periods of time may be changed at any time and may vary over time to reflect seasonal or periodic changes in business sales as well as special events, recurring events, recurring special events, and the like. Periods of time may be automatically determined based on previous data collected by the subject technology or may be defined, inputted, or changed by a managing user. Periods of time may be isolated for analysis with the subject technology to more accurately and efficiently isolate transactions of similar amounts, gratuity amounts, and to group transactions together share other common characteristics.

In step 420, at least one type of employee is determined for the time period. The term “type of employee” as used herein encompasses its plain and ordinary meaning, including, but not limited to a class of employee or other criteria based on the pay scale, duties, access, or privileges of an employee. Examples of types of employees include, but are not limited to, managers, corporate/administrative, server (i.e., wait staff), bartender, aesthetician, or cashier. The type of employee may be determined as having at least a threshold amount of the total sales of the enterprise and/or business. One exemplary threshold amount may be ten percent of the total sales of the enterprise and/or business as determined by a day, week, month, year, or the like. Types of employees may be specified or changed at any time by a managing user. By grouping employees with similar duties, similar levels of access, and privileges, patterns of transactions and patterns of the actions of groups of employees may be more readily identified.

In step 430, the group of employees is determined as a group of all employees of the same type for a single time period of a single enterprise of the business. The group of employees may include all the employees of a single type for the specified time period and enterprise. The group of employees may constitute all employees of a specific type for a period of time of the enterprise. The group of employees may exclude employees meeting additional criteria. As one example, the group of employees may exclude employees that do not have a count of cash bills equal to or more than the count of days in the query date range and/or greater than twenty-five percent of the average count of cash bills. Such criteria may be selected to provide a group of employees that is more reflective of an “average” employee for the type, period of time, and enterprise. A managing user may additional specify that a specific employee is included or excluded from a group of employees regardless of the employee's additional criteria or type. Steps 400-430 may be conducted prior to, as part of or during step 300 of FIG. 3. Steps 400-430 may additionally be conducted at any other time to redefine or update the employees identified as the group of employees. In one example, a group of employees may be identified as all the servers that are working the dinner shift in one particular restaurant (i.e., enterprise) of a hotel (i.e., business). A newly hired server working the dinner shift in that restaurant who is not yet able to open or close bills at the point of sale may be excluded from the group of employees until the new employee has a count of cash bills equal to or more than the count of days in the specified query.

In step 310, a plurality of bills of each employee of the group is identified. A “bill” as used herein encompasses its plain and ordinary meaning, including, but not limited to a bill corresponding to a financial transaction in which goods and/or services are exchanged for a price. A single bill may include several covers, i.e., goods and/or services for multiple customers that may later be split for payment in multiple transactions. A non-limiting example of a single bill with multiple covers is a restaurant bill that is generated for a party of four customers. The bill may then be split into covers by a variety of methods, such as evenly splitting the total amount of the bill for payment in two, three, or four transactions; the bill may alternatively be split by customer such that the dinners and drinks of the customers are split into separate covers based on the specific items purchased by each customer. The plurality of bills of each employee may be identified as all bills that have been opened and/or closed by each employee. Additional details regarding the plurality of bills may be determined, such as the method of payment as cash or non-cash payment. A bill may be transferred to another bill for all or partial payment. Promotions and voids may additionally be applied to a bill.

In step 320, it is determined for each bill whether a plurality of conditions have been met. The determined conditions may include two or more of: whether a complimentary condition has been met, whether a transfer condition has been met, whether a void and promotion condition has been met, whether a gratuity inflation condition has been met, whether a point of sale authorization condition has been met, whether an automatic gratuity condition has been met, and whether a bill reuse condition has been met. Step 320 may include the determination of additional conditions and/or may include the determination of all conditions. Each condition may include several determinations. Conditions or determinations may be reflected by assigning a flag to each bill identifying individual conditions and/or determinations that have been met. In addition to the determination of the plurality of conditions, the method of payment may also be determined and/or assigned a flag based on the type of payment used to close the bill including but not limited to, cash, credit card, debit card, comp, or any combination thereof.

Determining a complimentary condition aids in establishing whether suspicious behavior is indicated through bills that have been completely paid using an offer, comp, discount, coupon, gift certificate, or other non-monetary means. The complimentary condition may include the determination of a plurality of complimentary conditions including whether a bill has been comped (i.e., a bill has been reduced to zero using a comp or other non-monetary payment for the entire bill); whether a bill has been comped and a cash bill has been closed by the same employee in less than a bill closing time threshold; whether a bill has been comped and the bill has a transfer from a cash bill; and whether the cash bill has been transferred to the bill, wherein the bill has been comped. A bill that has been reduced to zero may be a bill that has been closed or marked as paid. An exemplary bill closing time threshold may be thirty minutes but could be any set amount of time.

Determining a transfer condition aids in establishing whether transfers of bills indicate suspicious behavior and may include a plurality of transfer conditions. The plurality of transfer conditions may include whether a bill has been comped; whether a bill has been comped and a cash bill has been closed by the same employee in less than a bill closing time threshold; whether a bill has been comped and the bill has a transfer from a cash bill; whether the cash bill has been transferred to the comped bill, where the bill has been comped; and whether a bill has been open for a time period longer than an open bill threshold amount. As the first three transfer conditions are determined as a portion of the complimentary conditions, redundant determinations need not be made in embodiments that determine both complimentary and transfer conditions, as with other redundancies amongst the conditions that follow. An exemplary period of time for the open bill threshold amount may be one standard deviation longer than the average duration for the group of employees for the last two months. The open bill threshold amount may be set at any amount.

Determining the void and promotion condition may include either a promotion amount or a void amount greater than zero that has been applied to the bill. A promotion amount may originate from an offer, partial “comp”, discount, coupon, voucher or the like. Voids on a bill are intended to be limited to occurrences when an error in order entry has occurred, a customer has returned an item, sent an item back, or has complained regarding services. The void and promotion conditions thus aid in identifying abnormalities in frequency or amounts of voids and promotions for a particular employee.

Determining the gratuity inflation condition may include a gratuity greater than an average of gratuities of the group of employees over a predetermined period of time. The predetermined period of time may be set any period of time; an exemplary time period is two months. Determining the gratuity inflation condition may additionally include a second determination of whether a promotion amount or a void amount greater than a respective average promotion amount or average void amount of the group of employees over a predetermined period of time. Although more highly skilled employees may receive higher gratuities than less skilled employees, the gratuity inflation condition aids in the identification of abnormal patterns in gratuities of specific employees or groups of employees.

Determining a point of sale authorization condition may include any one or more of point of sale authorization conditions including a void or promotion amount without a corresponding manager authorization, a void or promotion amount with a non-manager authorization, a void or promotion amount with an authorization from the same employee generating the bill, and a plurality of void or promotion amounts on the same bill with different authorizations. The point of sale authorization condition aids in the identification of patterns of suspicious use of voids and promotions and may help to identify abnormal behavior amongst employees.

Determining the automatic gratuity condition includes any one or more automatic gratuity conditions including a service charge or an automatic gratuity, a gratuity greater than a payment quantity of the bill amount, a gratuity percent greater than an average gratuity percent of the group of employees over a predetermined period of time, a number of gratuities greater than the number of payments of the bill (accounting for a number of tips/gratuities exceeding the number of payments, such as a bill paid with part cash, part credit card with more than two gratuities paid to the bill), and an employee's average revenue per customer (accounting for multiple customers on a single bill) is lower than an average revenue per customer for the group of employees over a predetermined period of time. An exemplary predetermined period of time may be two months, but may be set at any period of time. The automatic gratuity condition may help identify employees that have suspiciously high or frequent automatic gratuities applied to their respective bills.

Determining the bill reuse condition includes any one or more bill reuse conditions including determining whether a bill has been open for a time period longer than an open bill threshold amount and determining whether a bill has fewer items than an item threshold amount. An exemplary open bill threshold amount may be one standard deviation longer than the average duration for the group of employees in the previous two month range; the open bill threshold amount may be set at any length of time. An exemplary item threshold amount may be four items, but may be individually selected at any number of items. The bill reuse condition may assist in determining whether false bills are being generated and closed.

The conditions may collectively further a goal of the invention by identifying specific abnormalities of employees at the point of sale. The use of multiple conditions provides analysis from multiple perspectives and benefits a goal of the invention of more accurately and efficiently identifying suspicious behavior.

In step 330, a score is calculated corresponding to each of the determined conditions. A complimentary score may be calculated as a total of three scores. For example a first score may be determined as the percentage of an employee's total bills that have been comped and a cash bill has been closed by the same employee in less than the bill closing time threshold. A second score may be determined as the percentage of an employee's total bills have been comped, bills that have been comped and a cash bill has been closed by the same employee in less than the bill closing time threshold, bills that have been comped and has a transfer from a cash bill, or cash bills having a transfer from a comped bill. The third score may be the difference between the employees second score and the second score as calculated for the group of employees. The total complimentary score may be the sum of all three scores.

A transfer score may be calculated as a total of four scores. The first score may be calculated as the percentage of an employee's total bills have been comped, bills that have been comped and a cash bill has been closed by the same employee in less than the bill closing time threshold, bills that have been comped and has a transfer from a cash bill, or cash bills having a transfer from a comped bill. The second score may be calculated as the difference between the employee's first score and a first score as calculated for the entire group of employees. The third score may be calculated as the percentage of comped bills and bills that have been open for a time period longer than an open bill threshold amount. The fourth score may be calculated as the difference between the employee's third score and a third score as calculated for the group of employees. The transfer score may be the sum of all four scores.

A void and promotion score may be calculated as a total of two scores. The first score may be calculated as the difference between the percentage of an employee's cash bills that met the void and promotional condition and the percentage of an employee's non-cash bills that have met the void and promotional condition. The second score may be the difference between the employees the percentage of an employee's cash bills that met the void and promotional condition and the percentage of cash bills that met the void and promotional condition as calculated for the group of employees. The void and promotion score may be the sum of the first and second score.

A gratuity inflation score may be calculated as a total of two scores. The first score may be calculated as the difference between the percentage of an employee's cash bills meeting both gratuity inflation conditions and the percentage of an employee's non-cash bills meeting both gratuity inflation conditions. The second score may be the difference between the percentage of the employee's non-cash bills meeting both gratuity inflation conditions and the percentage of the group of employee's non-cash bills meeting both gratuity inflation conditions. The gratuity inflation score may be the sum of the first and second score.

A point of sale authorization score may be calculated as a total of two scores. The first score may be calculated as the percentage of bills meeting any of the plurality of point of sale authorization conditions. The second score may be calculated as the difference between the percentage of cash bills meeting any of the plurality of point of sale authorization conditions and the percent of non-cash bills meeting any of the plurality of point of sale authorization conditions. The point of sale authorization may be the sum of the first and second score.

An automatic gratuity score may be calculated as a total of four scores. The first score may be calculated as the percentage of bills including a service charge or an automatic gratuity and a gratuity greater than the number of payments of the bill. The second score may be calculated as the percentage of bills with a gratuity greater than the number of payments of the bill amount. The third score may be calculated as the percentage of bills including a service charge, a gratuity greater than the average gratuity percent of the group of employees, and the employee's average revenue per customer is lower than an average revenue per customer for the group of employees. The fourth score may be calculated as the percentage of bills with a gratuity greater than the number of payments, the percent of bills with a gratuity percent greater than an average gratuity percent of the group of employees, and the employee's average revenue per customer is lower than an average revenue per customer for the group of employees. The automatic gratuity score may be the sum of all four scores.

A bill reuse score may be calculated as a total of two scores. The first score may be calculated as a percent of non-cash bills meeting both the bill reuse conditions. The second score may be calculated as the average group of employees number of cash bills per hour and the employees cash bills per hour. The bill reuse score may be the sum of the first and second score.

In step 340, a total score is established for each employee of the group based on the score for the determined conditions for each of the plurality of bills. Additional scores may be determined based on a combination of determined conditions or a combination of portions of determined conditions. The score may be the sum of each the calculated scores.

In step 350, each employee of the group is rated based on the total score of each respective employee. An alert level may be determined for each employee based on the rating of each employee of the group and further based on the employee's rating for each condition and corresponding score. The score may be calculated for an employee, may be calculated based on the comparison of conditions of one employee to the conditions of the group of employees, and may be calculated based on scores over time. Ratings for each condition and corresponding score may be calculated in a variety of ways, and exemplary calculations of ratings are described below. Any and all numerical values presented in the exemplary calculations of ratings as described below are representative of variable values (e.g., dividing by one hundred fifty as disclosed below may be one hundred, two hundred, one hundred seventy-five, or any other number in alternative embodiments). Additional embodiments of each of the rating calculations below are contemplated using variable values. These values may be preset, determined for each specific business and/or enterprise, or variable by a managing user. The employee's total rating may be the sum or average of ratings calculated for each determined condition and corresponding score. For employees that have multiple job types, work in multiple time periods, and/or multiple enterprises, the employee's overall rating may be determined by calculating the employee's rating for each subset of job type, time period, and/or enterprise, with the overall rating weighted by the proportion of the employee's total sales in each subset.

A complimentary rating is zero if the complimentary score is less than zero. For a complimentary score greater than zero, the complimentary rating is the complimentary score divided by one hundred fifty, with the resulting value multiplied by one hundred. A transfer rating is zero if the transfer score is less than zero. For a transfer score greater than zero, the transfer rating is the transfer score divided by two hundred, with the resulting value multiplied by one hundred. A void and promotion rating is zero if the void and promotion score is less than zero. For a void and promotion score greater than zero, the void and promotion rating is the void and promotion score divided by one hundred, with the resulting value multiplied by one hundred. A gratuity inflation rating is zero if the gratuity inflation score is less than zero. For a gratuity inflation score greater than zero, the gratuity inflation rating is the gratuity score divided by one hundred, with the resulting value multiplied by one hundred. A point of sale authorization rating is zero if the point of sale authorization score is less than zero. For a point of sale authorization score greater than zero, the point of sale authorization rating is the point of sale authorization score divided by one hundred, with the resulting value multiplied by one hundred. A automatic gratuity rating is zero if the automatic gratuity score is less than zero. For an automatic gratuity rating greater than zero, the automatic gratuity rating is the automatic gratuity score divided by two hundred, with the resulting value multiplied by one hundred. A bill reuse rating is zero if the bill reuse score is less than zero. For a bill reuse score greater than zero, the bill reuse score is the bill reuse score divided by one hundred, with the resulting value multiplied by one hundred. Ratings may additionally be determined for a time period, group of employees, and/or enterprise by averaging individual ratings of all the employees for a time period, group of employees, and/or enterprise.

The method may further include ranking each bill of each employee of the group based on one or more of a complimentary ranking, a transfer ranking, a void and promotion ranking, a gratuity inflation ranking, a point of sale authorization ranking, an automatic gratuity ranking, and a bill reuse ranking. A complimentary ranking may be a sorting of the bills based on their dollar value total from highest to lowest. Bills may be sorted such that cash bills that have been transferred from a comped bill are ordered next to its corresponding comped bill. A complimentary ranking may be limited to only comped bills, comped bills and corresponding transferred cash bills that have been closed by the same employee in less than the bill closing time threshold, comped bills that have a transfer from a cash bill, cash bills having a transfer from a comped bill, or a combination thereof. A transfer ranking may be a sorting of the bills from the longest to shortest amount of time that the bill has remained open. Bills may be sorted such that cash bills that have been transferred from a comped bill are ordered next to its corresponding comped bill. A transfer ranking may be limited to only comped bills, comped bills and corresponding transferred cash bills that have been closed by the same employee in less than the bill closing time threshold, comped bills that have a transfer from a cash bill, cash bills having a transfer from a comped bill, or a combination thereof. A void and promotion ranking may be a sorting of the bills from the highest dollar value void and/or promotion to the lowest. A void and promotion ranking may be limited to cash bills or non-cash bills only. A gratuity inflation ranking may be a sorting of the bills from the highest gratuity to the lowest. The gratuity inflation ranking may be limited to cash bills or non-cash bills only, or may be limited to bills meeting any one or more of the gratuity inflation conditions. A point of sale authorization ranking may be a sorting of the bills from the total void and/or promotion amount from highest to lowest. The point of sale authorization ranking may be limited to cash bills or non-cash bills only and/or may be limited to bills that have met any one or more of the point of sale authorization conditions. An automatic gratuity ranking may be a sorting of the bills from the highest gratuity percentage to the lowest. The automatic gratuity ranking may be limited to only bills that meet a specific automatic gratuity condition or a combination of automatic gratuity conditions. The automatic gratuity ranking may be further sorted by ranking bills meeting a specific automatic gratuity condition higher than bills that do not. A bill reuse ranking may be a sorting of the bills from the longest to shortest amount of time that the bill has remained open. The bill reuse ranking may be limited to only bills that meet one of the bill reuse conditions and may be further limited to cash or non-cash bills only.

The method may further include sending an alert to a managing user based on the rating of one or more employees of the group. An alert may be sent to a managing user (e.x., manager, employer, or other designated user of an enterprise or business based on the employees associated with the respective enterprise). Multiple managing users may be designated for a business and/or enterprise. The alert may be sent in the form of an email, text message, voicemail, SMS, or may be sent to a corresponding managing user account that is accessible via a graphical user interface in a web browser or via a graphical user interface of an application stored on the managing user's client device. The term “alert” as used herein encompasses its plain and ordinary meaning, including, but not limited to a message, report, or notification indicating new or updated information related to the subject technology. The alert may contain the new or updated information and/or direct the managing user to log into a managing user account in which the new or updated information is stored. The type or content of an alert may be customizable by the managing user. Alerts may be generated at regular intervals on a rolling basis. The alert may include multiple priority levels associated with the priority of the contents of the alert. Priority levels may differ for different types of information. Examples of priority levels include high, medium and low. Alerts may be related to a business, enterprise or employee. Alerts may be generated to indicate a trend for one or more of the business, enterprise, or employee. The use of alerts provides the benefit of time efficient and timely notification that an issue has arisen or that a change in employee behavior has occurred.

Alerts may be assigned an alert level based on the rating of the employee or enterprise. Exemplary alert levels include red level, orange level, yellow level, and green level corresponding to the rating of each employee or outlet. For example, the red level may be assigned to a score greater than forty, the orange level be assigned to a score between twenty and forty, the yellow level may be assigned to a score between five and twenty, and the green level may be assigned to a score between zero and five. Using color coding provides an easily identifiable indication of degree of severity of a rating or alert level.

One example of priority levels for use with a report for an entire enterprise may include a high priority level alert indicating that two or more employees have red level ratings. A medium priority level alert for an enterprise may indicate that two or more employees have orange level ratings. A low priority level alert may indicate that one employee has a red level rating, two or more employees have orange level ratings, or that five or more employees have yellow level ratings. The number of employees at each level may be set as a threshold at any number of the managing user's selection or may be preset by the subject technology.

One example of priority levels for use with a report for an employee of an enterprise may include a high priority level alert indicating that two or more conditions have a red level rating. A medium alert for an employee of an enterprise may indicate that two or more conditions have an orange level rating or one condition with an orange level rating and one condition with a red level rating. A low alert for an employee of an enterprise may indicate three or more conditions with yellow level ratings or, in the alternative, one or more condition types with yellow level ratings and one condition type with an orange level rating. The number of conditions at each level may be set as a threshold at any number of the managing user's selection or may be preset by the subject technology.

An alert may provide or direct the managing user to a report of the performance of one or more enterprise of a business or for all enterprises of the business based on the ratings, scores, or other information associated with the employees or groups of employees of the enterprise or business.

A trend alert may have a high priority level for an enterprise rating increasing by fifteen percent and two or more employees moved to red. A medium priority level for a trend alert for an enterprise may be an enterprise rating increasing by fifteen percent and two or more employees moving to orange or red. A low priority level for a trend alert for an enterprise may be an enterprise rating increased by fifteen percent and two or more employees moving to a yellow, orange, or red rating. Numerical values may be set as a threshold at any number of the managing user's selection or may be preset by the subject technology. Trend alerts provide the benefit of identifying changes in behavior quickly. Trend alerts additionally may notify a managing user that suspicious behavior has been resolved.

Any alert may additionally be assigned a unique case number that may be used to track the progress of the subject of the alert. Case numbers may be organized such that groups of alerts and related alerts are easily identified. Alerts may additionally be assigned a status indicating additional information about the alert. Examples of alert status include new, investigating, no action, and resolved. An alert status of “new” may indicated that a new alert has been generated at the start of the reporting period. An alert status of “investigating” may indicate that the alert may be moved into the case report. An alert status of “no action” may indicate that the alert has not changed since the last time cycle and has not been indicated as a situation that is under investigation. An alert status of “resolved” indicates that the underlying situation has been resolved. A managing user may designate the status of each alert through a graphical user interface in order to more easily organize and identify cases of relevance to the managing user.

The managing user may further manage the subject technology by individually closing any section of a case. The graphical user interface may provide suggestions to the user based on the managing user's input. An example of such a suggestion is if the managing user selects all sections of a case closed, the managing user may be prompted to change the status of the entire case to “resolved.” If a managing user re-opens a section of a case that is currently marked “resolved,” the managing user may be prompted to change the status of “resolved” to “investigating.” A managing user may be provided with additional selections when changing the status of the case in order to identify the reason the status has changed. For example, for a status change to “resolved,” the managing user may be provided with additional selections to indicate the reason the case is resolved such as “training issue”, “fraud found/employee terminated”, or the like. The managing user may also be provided with a space to create entries indicating the case status.

FIG. 5 illustrates an example graphical user interface (GUI) 500 of the method and system of fraud detection. Alerts and other information related to the subject technology may be available to the managing user via a managing user account accessible through a web browser of client device 250. GUI 500 may additionally be accessible to the managing user via a mobile application, email, and the like. The GUI 500 may be customized by the managing user to display only the information of interest to the managing user. Multiple enterprises 510 may be displayed through GUI 500. The score and rating of each employee 530 may be displayed on the GUI 500 in a variety of forms. The numeric value of the score may be displayed next to the employee's name and the rating of the employee may be displayed as a color-coded box around the score. The color may correspond to the level of rating associated with the score of the employee. The score and rating of each identified employee 530 may be the total score of the employee or may further correspond to a specific condition 540 of interest to the managing user. Priority level of the alert 520 may be displayed and may additionally be color coded to indicate the level of the alert. The specific condition 540 triggering the alert may also be shown on GUI 500. The GUI may display additional information such as the case number, status, and an area for notes that may be entered by the managing user through an input device of the client device 250. The alert information shown on GUI 500 may additional or alternatively sent to the managing user in the illustrated form or in text only form through email, text message, or other means.

FIG. 6 illustrates an example GUI 600 of the method and system of fraud detection. More detailed information regarding individual cases may be available to the managing user through a variety of screens. Reports may be generated based on any or all of the analyzed and original bill information, and may be customizable through GUI 600. Alert information such as enterprise 610, priority level of alert 620, status and rating of each identified employee 630, and a specific condition 640 triggering the alert may be displayed as part of GUI 600. Additional report information for individual bills (i.e., check #) date, sales amount, gratuity amount, pay method, or other information may be displayed on GUI 600. GUI 600 may additionally provide access to individual bills, additional reports, or other information by providing hyperlinks, menus or mechanisms for user interaction in order to provide easy access to additional information.

Portions of the description above may be implemented as software processes that exists as a set of instructions recorded on a computer-executable storage medium (also called computer-readable storage medium, computer-readable medium, machine-executable storage medium, or machine-readable storage medium). These instructions, when executed by one or more processors, cause the processor(s) to perform the actions indicated by the instructions. Examples of computer-executable media include, but are not limited to, ROM, recordable and rewriteable compact discs (CD), rewriteable compact discs, recordable and rewritable digital versatile discs (DVD), CD-ROMs, flash memory, RAM, magnetic and/or solid state hard drives, EPROMs, optical discs, magnetic media, floppy discs, and the like. Computer-executable storage mediums exclude any wireless signals, wired download signals, and any other ephemeral signals.

The term “software” as used herein encompasses its plain and ordinary meaning, including, but not limited to, firmware and/or applications stored in magnetic storage, which may be read into memory for execution by a processor. Multiple software aspects of the subject technology may be implemented as portions of a larger program while remaining distinct software aspects of the subject technology. Multiple software aspects may also be implemented as separate programs.

The methods and instructions performed by systems of the subject technology may be written in any form of programming language, computer programs and software of the subject technology may be executed on one or more computers exists at a single location or may be spread over multiple locations, connected by a communication network. Computers that perform the method of the subject technology and make up portions of the system of the subject technology may be general or special purpose computing devices and storage device that communicate over a network. The terms “computer”, “server”, “processor”, and “memory” all refer to electronic or other technological devices. These terms exclude people or groups of people.

It is understood that any specific order or hierarchy of steps in the methods of the subject technology are illustrations of example approaches. The specific order or hierarchy of steps in the method may be rearranged based on design preferences. Some embodiments may not require that all illustrated steps be performed. Some steps may be performed simultaneously, which may provide multitasking and/or parallel processing advantages.

The instant description is provided to enable any person skilled in the art to practice the various aspects described herein. Modifications to these aspects will be readily apparent to those skilled in the art, and the generic principles defined herein may be applied to other aspects. Accordingly, the claims are not intended to be limited to the illustrated and described aspects or embodiments, but should be accorded the full scope consistent with the language of the claims. Reference in the singular is not intended to mean “one or more” and not “one and only one” unless specifically stated. Unless otherwise specifically stated, the term “some” refers to one or more. Pronouns should be interpreted as inclusive of masculine, female, and gender neutral. Heading and subheadings, if any, are used for organizational clarity and do not limit the subject technology. Embodiments and aspects described under one heading or one subheading may be combined, in various embodiments, with features described under other headings or subheadings. Not all features under a single heading or a single subheading are necessarily used together in embodiments.

The terms “aspect” and “configuration” as used herein do not imply that such aspect or such configuration is essential to the subject technology or that such aspect or configuration applies to all configurations of the subject technology. The term “example” or “exemplary” as used herein means “serving as an example or illustration.” Any use of the term “example” or “exemplary” does not indicate a preference or advantage over other aspects or designs except where specifically stated. All structural and functional equivalents to the elements of the various aspects described throughout this disclosure that are known or later come to be known to those of ordinary skill in the art are intended to be encompassed by the claims.

What is claimed is:

1. A computer implemented method of fraud detection, the method comprising:
identifying a group of employees, wherein the group of employees comprises a plurality of employees;
identifying a plurality of bills of each employee of the group;
determining, for each bill, whether a plurality of conditions have been met, wherein the determined conditions comprise at least two of:
whether a complimentary condition has been met,
whether a transfer condition has been met,
whether a void and promotion condition has been met,
whether a gratuity inflation condition has been met,
whether a point of sale authorization condition has been met,
whether an automatic gratuity condition has been met, and
whether a bill reuse condition has been met;
calculating a score corresponding to each of the determined conditions;
establishing a total score for each employee of the group based on the score for the determined conditions for each of the plurality of bills; and
rating each employee of the group based on the total score of each employee of the group.

2. The method of claim 1, wherein identifying the group of employees further comprises:
determining at least one enterprise of a business;
determining at least one time period of operation for the enterprise;
determining at least one type of employee for the time period; and
determining the group of employees as all employees based on the at least one type of employee for the single time period of the single enterprise of the business.

4. The method of claim 1, the method further comprising:
determining a method of payment, wherein the method of payment is a cash payment or a non-cash payment.

5. The method of claim 1, the method further comprising:
ranking each bill of each employee of the group based on at least two of:
a complimentary ranking,
a transfer ranking,
a void and promotion ranking,
a gratuity inflation ranking,
a point of sale authorization ranking,
an automatic gratuity ranking, and
a bill reuse ranking.

6. The method of claim 2, the method further comprising:
determining an alert level for each employee based on the rating of each employee of the group.

7. The method of claim 1, wherein the complimentary condition comprises a plurality of complimentary conditions including:
a bill has been reduced to zero using a nonmonetary payment;
a bill has been reduced to zero using a nonmonetary payment and a cash bill has been closed by the same employee in less than a bill closing time threshold;
a bill has been reduced to zero using a nonmonetary payment and the bill has a transfer from a cash bill; and
the cash bill has been transferred to the bill, wherein the bill has been reduced to zero.

8. The method of claim 1, wherein the transfer condition comprises a plurality of transfer conditions including:
a bill has been reduced to zero using a nonmonetary payment;
a bill has been reduced to zero using a nonmonetary payment and a cash bill has been closed by the same employee in less than a bill closing time threshold;
a bill has been reduced to zero using a nonmonetary payment and the bill has a transfer from a cash bill;
the cash bill has been transferred to the bill, wherein the bill has been reduced to zero using a nonmonetary payment; and
a bill has been open for a time period longer than an open bill threshold amount.

8. The method of claim 1, wherein the void and promotion condition comprises a promotion amount or a void amount greater than zero.

9. The method of claim 1, wherein the gratuity inflation condition comprises a gratuity greater than an average of gratuities of the group of employees over a predetermined period of time.

10. The method of claim 1, wherein the gratuity inflation condition comprises a promotion amount or a void amount greater than a respective average promotion amount or average void amount of the group of employees over a predetermined period of time.

11. The method of claim 1, wherein the point of sale authorization condition comprises any one or more point of sale authorization conditions including:
a void or promotion amount without a corresponding manager authorization,
a void or promotion amount with a non-manager authorization,
a void or promotion amount authorization from the same employee generating the bill, and
a plurality of void or promotion amounts with different authorizations.

12. The method of claim 1, wherein the automatic gratuity condition comprises any one or more automatic gratuity conditions including:
a service charge or an automatic gratuity,
a gratuity greater than a payment quantity of the bill amount,
a gratuity percent greater than an average gratuity percent of the group of employees over a predetermined period of time,
a number of gratuities greater than the number of payments of the bill, and
a revenue per customer less than an average revenue per customer of the group of employees over the predetermined period of time.

13. The method of claim 1, wherein the bill reuse condition comprises any one or more bill reuse conditions including:
a bill has been open for a time period longer than an open bill threshold amount, and
a bill has fewer items than an item threshold amount.

14. The method of claim 1, the method further comprising:
sending an alert to a client device based on the rating of one or more employees of the group.

15. A system for fraud detection, the system comprising:
one or more processors; and
a memory containing processor-executable instructions that, when executed by the one or more processors, cause the system to:
identify a group of employees, wherein the group of employees comprises a plurality of employees;
identify a plurality of bills of each employee of the group;
determine, for each bill, whether a plurality of conditions have been met, wherein the determined conditions comprise:
whether a complimentary condition has been met,
whether a transfer condition has been met,
whether a void and promotion condition has been met,
whether a gratuity inflation condition has been met,
whether a point of sale authorization condition has been met,
whether an automatic gratuity condition has been met, and
whether a bill reuse condition has been met;
calculate a score corresponding to each of the determined conditions;
establish a total score for each employee of the group based on the score for the determined conditions for each of the plurality of bills; and
rate each employee of the group based on the total score of each employee of the group.

16. The system of claim 15, the memory further comprising instructions causing the system to:
determine at least one enterprise of a business;
determine at least one time period of operation for the enterprise;
determine at least one type of employee for the time period; and
determine the group of employees as all employees based on the at least one type of employee for the single time period of the single enterprise of the business.

17. The system of claim 15, the memory further comprising instructions causing the system to:
rank each bill of each employee of the group based on:
a complimentary ranking,
a transfer ranking,
a void and promotion ranking,
a gratuity inflation ranking,
a point of sale authorization ranking,
an automatic gratuity ranking, and
a bill reuse ranking.

18. The system of claim 15, the memory further comprising instructions causing the system to:
send an alert to a client device based on the rating of one or more employees of the group.

19. The system of claim 16, the memory further comprising instructions causing the system to:
send an alert to a client device based on one or more enterprises.

20. A machine-readable storage medium storing machine-executable instructions for causing a processor to perform a method for fraud detection, the method comprising:
identifying a group of employees, wherein the group of employees comprises a plurality of employees;
identifying a plurality of bills of each employee of the group;
determining, for each bill, whether a plurality of conditions have been met, wherein the determined conditions comprise at least two of:
whether a complimentary condition has been met,
whether a transfer condition has been met,
whether a void and promotion condition has been met,
whether a gratuity inflation condition has been met,
whether a point of sale authorization condition has been met,
whether an automatic gratuity condition has been met, and
whether a bill reuse condition has been met;
calculating a score corresponding to each of the determined conditions;
establishing a total score for each employee of the group based on the score for the determined conditions for each of the plurality of bills;
rating each employee of the group based on the total score of each employee of the group; and
sending an alert to a client device based on one or more employees.
